(19) United States
(12) Patent Application Publication
(10) Pub. No.: US 2017/0192388 A1
(43) Pub. Date: Jul. 6, 2017

(54) HOLOGRAM, LIGHT-TRANSMISSIVE REFLECTOR PLATE, SCREEN, AND PROJECTION SYSTEM USING THEM

(71) Applicant: Dai Nippon Printing Co., Ltd., Tokyo (JP)

(72) Inventors: Mitsuru KITAMURA, Tokyo (JP); Dai TSUKADA, Tokyo (JP)

(73) Assignee: Dai Nippon Printing Co., Ltd., Tokyo (JP)

(21) Appl. No.: 15/314,199

(22) PCT Filed: Jun. 1, 2015
(86) PCT No.: PCT/JP2015/065809

§ 371 Date: Nov. 28, 2016

(30) Foreign Application Priority Data
Jun. 3, 2014 (JP) 2014-114584

(51) Int. Cl. G03H 1/02

(52) U.S. Cl. CPC G03H 1/0256; G03H 2001/2228

(57) ABSTRACT

To provide a hologram, a light-transmissive reflector plate, a screen, and a projection system capable of achieving high transparency and allowing a projected image to be brightly and clearly reflected and observed.

A hologram 1 has a relief part, wherein the hologram 1 reflects a given white light incident thereon at a given angle from one side, while transmits a given white light incident thereon at a given angle from the other side, and diffraction efficiency for transmitted light and diffraction efficiency for reflected light differ from each other.

### TECHNICAL FIELD

The present disclosure relates to a hologram, a light-transmissive reflector plate, and a screen that transmit a white light emitted from one side while reflect a white light emitted from the other side so as to achieve white light observation, and a projection system using them.

### BACKGROUND ART

Patent Document 1 discloses a transparent screen using a volume-type hologram.

### CITATION LIST

### Patent Document

Patent Document 1: JP 09-33856 A

### DISCLOSURE OF THE INVENTION

### Problems to be Solved by the Invention

However, in the technology described in Patent Document 1, an expensive photosensitive material needs to be used as the volume-type hologram, and the manufacturing thereof involves an exposure process based on laser light irradiation, thus degrading mass productivity. Further, the volume-type hologram has wavelength selectivity in that only a specific wavelength is strongly diffracted, thus posing a problem that a display is unnecessarily colored.

An object of the present invention is to provide a computer-generated hologram, a light-transmissive reflector plate, a screen, and a projection system capable of achieving high transparency and allowing a projected image to be brightly and clearly reflected and observed.

### Means for Solving the Problems

A hologram according to one embodiment of the present invention has a relief part, wherein the hologram reflects a given white light incident thereon at a given angle from one side, while transmits a given white light incident thereon at a given angle from the other side, and diffraction efficiency for transmitted light and diffraction efficiency for reflected light differ from each other.

In the hologram according to the one embodiment of the present invention, the diffraction efficiency for transmitted light is lower than the diffraction efficiency for reflected light.

In the hologram according to the one embodiment of the present invention, a ratio of the diffraction efficiency for transmitted light to the diffraction efficiency for reflected light is less than 0.2.

In the hologram according to the one embodiment of the present invention, the ratio of the diffraction efficiency for transmitted light to the diffraction efficiency for reflected light is less than 0.1, and the diffraction efficiency for reflected light is equal to or more than 60%.

In the hologram according to the one embodiment of the present invention, the depth of the relief part is set to a plurality of different values.

The hologram according to the one embodiment of the present invention is a computer-generated hologram.

A light transmissive reflector plate according to one embodiment of the present invention includes the above hologram, wherein the reflector plate reflects a given white light incident thereon at a given angle from one side of the hologram, while transmits a given white light incident thereon from the other side thereof, and diffraction efficiency for transmitted light and diffraction efficiency for reflected light differ from each other.

The light transmissive reflector plate according to the one embodiment of the present invention has a reflective layer formed in the relief part of the hologram.

The light transmissive reflector plate according to the one embodiment of the present invention has a low-diffraction-efficiency layer that is disposed so as to fill up the relief part of the hologram and reduces the diffraction efficiency for light transmitted through the hologram.

In the light transmissive reflector plate according to the one embodiment of the present invention, the difference between the refractive index of the hologram and the refractive index of the low-diffraction-efficiency layer is set to a value equal to or less than 0.25.

A screen according to one embodiment of the present invention has the above hologram or the light transmissive reflector plate.

A projection system according to one embodiment of the present invention has the screen and a projector that emits a given white light toward the screen at a given angle.

### Advantages of the Invention

According to the hologram, light transmissive reflector plate, screen, and projection system, it is possible to achieve high transparency and to allow a projected image to be brightly and clearly reflected and observed.

### BRIEF DESCRIPTION OF THE DRAWINGS

FIG. 1 is a conceptual view of a projector screen using a computer-generated hologram according to the present embodiment;

FIG. 2 is a schematic view of the screen according to the present embodiment;

FIG. 3 is a schematic view of a screen according to a first embodiment;

FIG. 4 illustrates the diffraction efficiency of the screen according to the first embodiment and the diffraction efficiency of another example;

FIG. 5 is a schematic view of a screen according to a second embodiment;

FIG. 6 is a schematic view of a screen according to a third embodiment;

FIG. 7 illustrates the diffraction efficiency of the screen according to the third embodiment;

FIG. 8 is a schematic view of a screen according to a fourth embodiment;

FIG. 9 illustrates an example of the diffraction efficiency of the screen according to the fourth embodiment;

FIG. 10 illustrates another example of the diffraction efficiency of the screen according to the fourth embodiment;

FIG. 11 illustrates a projector screen of a first example according to the present embodiment;

FIGS. 12A and 12B illustrate an elemental hologram group of the projector screen of the first example according to the present embodiment;

FIG. 13 illustrates a projector screen of a second example according to the present embodiment;

FIGS. 14A to 14C illustrate an example of the phase distribution of the computer-generated hologram used in the projector screen of the first example according to the present embodiment;

FIG. 15 is a flowchart illustrating calculation steps for the computer-generated hologram used in the projector screen of the first example according to the present embodiment;

FIG. 16 illustrates a range of exit light with respect to light incident on the computer-generated hologram used in the projector screen of the first example according to the present embodiment;

FIGS. 17A to 17C illustrate diffraction of each wavelength when the observation region set for the computer-generated hologram used in the projector screen of the first example according to the present embodiment is narrow;

FIG. 18 illustrates diffraction of each wavelength when the observation region set for the computer-generated hologram used in the projector screen of the first example according to the present embodiment is narrow;

FIGS. 19A to 19C illustrate diffraction of each wavelength when the observation region set for the computer-generated hologram used in the projector screen of the first example according to the present embodiment is wide; and

FIG. 20 illustrates diffraction of each wavelength when the observation region set for the computer-generated hologram used in the projector screen of the first example according to the present embodiment is wide.

### EMBODIMENTS FOR CARRYING OUT THE INVENTION

Hereinafter, a case where a light-transmissive reflector plate including a hologram according to an embodiment of the present invention is used as a projector screen 10 used in a projection system 20 will be described with reference to the drawings. The projector screen 10 according to the present embodiment is used by being stuck to a window or a showcase for displaying and selling goods and is capable of allowing not only observation of an image projected from a projector P with high brightness, but also observation of a background view or the inside of the showcase with high transmittivity.

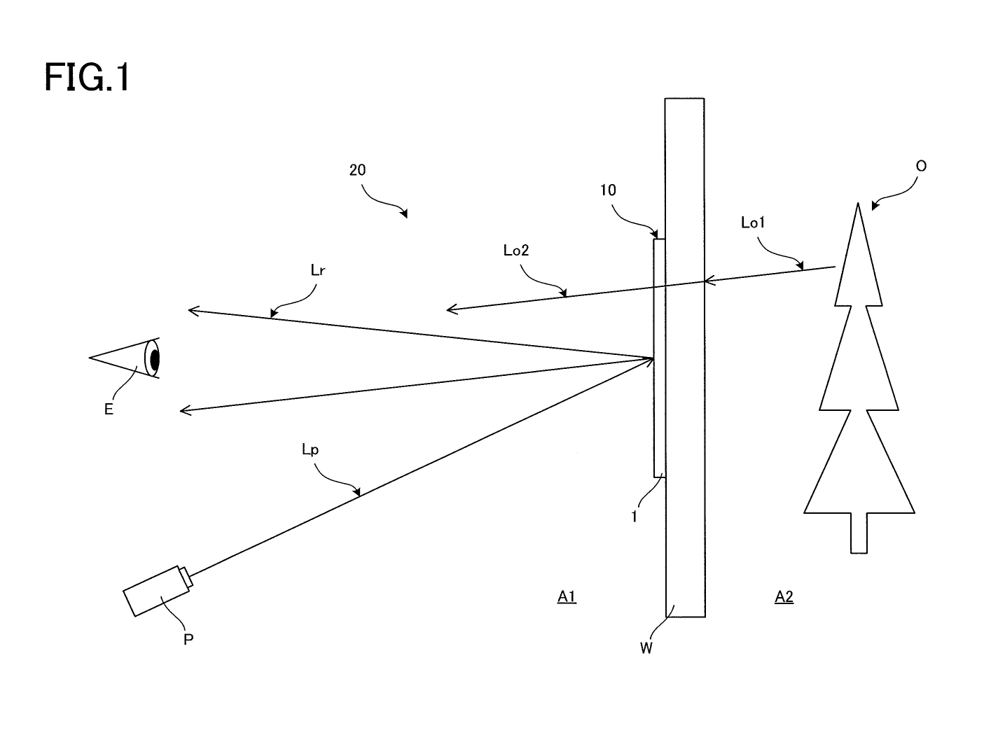

FIG. 1 is a conceptual view of the projector screen according to the present embodiment.

The projector screen 10 (hereinafter, referred to merely as “screen”) used in the projection system 20 according to the present embodiment has high transparency and reflects clearly a projected image. To achieve this, the screen 10 according to the present embodiment is formed using a hologram having diffraction efficiency higher for reflected light than for transmitted light. The hologram to be used may be a surface relief hologram, an embossed hologram, or a computer-generated hologram. In the following embodiments, a computer-generated hologram 1, which is a more practical example, is taken as the hologram of the screen 10.

For example, as illustrated in FIG. 1, the screen 10 is used by being stuck to a window W. Normally, an object light Lo1 from an object O behind the screen 10 can be transmitted through the screen 10 as a transmitted light Lot without being diffused. That is, the object light Lo1 is hardly influenced by the diffraction function of the hologram. Thus, the screen 10 has a high see-through property, thereby allowing accurate observation of a background view (outside view).

When an image is projected on the screen 10 from the projector P, an incident light Lp is reflected and diffused at the screen 10, and a reflected light Lr is observed as an image by an observer E. In FIG. 1, the incident light Lp emitted from the projector P is represented by a straight line; actually, however, the incident light Lp from the projector P is made incident on the screen 10 while being diffused and then reflected at various incident positions on the screen 10. The reflected light Lr is diffused in a given range by the diffraction function of the hologram and can thus be observed with high brightness.

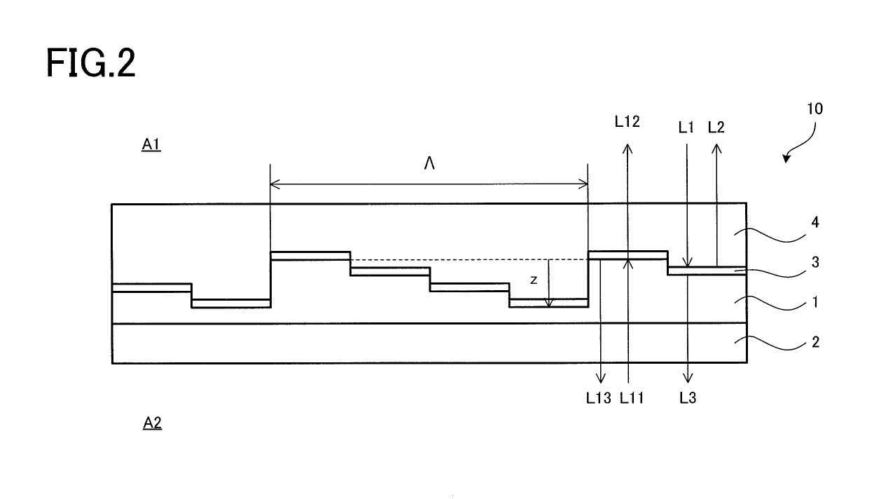

FIG. 2 is a schematic view of the screen 10 according to the present embodiment.

The screen 10 according to the present embodiment has a computer-generated hologram 1, a substrate 2, a reflective layer 3, and a low-diffraction-efficiency layer 4. The screen 10 may have at least the computer-generated hologram 1. The computer-generated hologram 1 is disposed adjacent to the substrate 2. A hologram layer may be obtained by forming a relief on the substrate layer 2 itself by heat pressure. The reflective layer 3 is disposed on the opposite side to the substrate 2 with respect to the computer-generated hologram 1 and formed on the computer-generated hologram 1. The low-diffraction-efficiency layer 4 is formed on the reflective layer 3 side of the computer-generated hologram 1. The low-diffraction-efficiency layer 4 is a layer for reducing diffraction efficiency for light transmitted through the hologram.

That is, the screen 10 is configured such that the low-diffraction-efficiency layer 4, reflective layer 3, and computer-generated hologram 1 are disposed in this order from the side of the projector P and observer E illustrated in FIG. 1, and the substrate 2 is disposed on the window W side, i.e., on the side closest to the object O.

Thus, when a first incident light L1 emitted from the projector P illustrated in FIG. 1 enters the low-diffraction-efficiency layer 4 from a region A1, it is reflected as a reflected light L2 at the reflective layer 3 and then transmitted through the low-diffraction-efficiency layer 4 once again to be emitted from the region A1. A part of the first incident light L1 is emitted to a region A2 side as a transmitted light L3. When a second incident light L11 from the external object O illustrated in FIG. 1 enters the substrate 2 from the region A2, it is transmitted as a transmitted light L12 through the computer-generated hologram 1, reflective layer 3, and low-diffraction-efficiency layer 4 to be emitted from the region A1. A part of the second incident light L11 is emitted to the region A2 side as a reflected light L13. The transmitted light L3 and reflected light L13 do not have influence on visibility of projector's reflected light on a reflective type see-through screen and visibility of transmitted light of an external object, so description thereof will be omitted hereinafter.

The screen 10 may be configured such that the substrate 2, computer-generated hologram 1, and reflective layer 3 are disposed in this order from the side of the projector P and observer E, and the low-diffraction-efficiency layer 4 is disposed on the window W side, i.e., on the side closest to the object O.

In this case, when the first incident light L1 emitted from the projector P illustrated in FIG. 1 enters the substrate 2 from the region A1, it is transmitted through the hologram formation layer 1 and reflected as the reflected light L2 at the reflective layer 3 and then transmitted through the hologram formation layer 1 and substrate 2 once again to be emitted from the region A1. When the second incident light L11 from the external object O illustrated in FIG. 1 enters the low-diffraction-efficiency layer 4 from the region A2, it is transmitted as the transmitted light L12 through the reflective layer 3, hologram formation layer 1, and substrate 2 to be emitted from the region A1.

In the case of a cyclic structure, a diffraction efficiency η is calculated by the following expression (1) according to the scalar diffraction theory:

$$\begin{matrix}[ Numeral 1 ] & \\ {η}_{m} = {\vert {T}_{m} \vert}^{2} & ( 1 ) \\ {T}_{m} = \frac{1}{Λ} {\int }_{0}^{A} exp [ i φ ( x ) ] exp ( - i \cdot 2 π mx / Λ ) dx & ( 2 )\end{matrix}$$

where Φ (x) stands for a phase, Λ for the grating interval of a diffraction grating, m for a diffraction order, i for an imaginary unit, and T, for the square root of diffraction efficiency ηₘ.

The phase φ is calculated by the following expression (3) in the case of a reflective type, and calculated by the following expression (4) in the case of a transmissive type:

[Numeral 2]

φ=2π(n₁·2z/λ) (3)

φ=2π(n₁=n₂)z/λ (4)

where n1 stands for the refractive index of one of the computer-generated hologram 1 and low-diffraction-efficiency layer 4 that is disposed on the observer E side, n2 for the refractive index of one of the computer-generated hologram 1 and low-diffraction-efficiency layer 4 that is disposed on the side opposite to the observer E side, λ for the wavelength of light, and z for a relief depth from a reference position.

As the substrate 2, employed is a transparent material, the thickness of which is reducible, having mechanical strength, and exhibiting solvent resistance and heat resistance to endure a process of producing a sheet, a label, and a transfer sheet of a computer-generated hologram recording medium. Depending on the purpose of use, the material for the substrate 2 is preferably a film-like or a sheet-like plastic, but not limited thereto.

Examples of the plastic film include films of polyethylene terephthalate (PET), polycarbonate, polyvinyl alcohol, polysulfone, polyethylene, polypropylene, polystyrene, polyarylate, triacetylcellulose (TAC), diacetylcellulose, and polyethylene/vinylalcohol.

From the same point of view, the thickness of the substrate 2 is preferably 5 μm to 500 μm, and more preferably, 5 μm to 50 μm. In forming a transfer sheet, a release layer formed of an acetylcellulose resin or a metacrylate resin may be usually provided on the substrate.

Examples of a transparent resin material constituting the computer-generated hologram 1 include various thermosetting resins, thermoplastic resins, and ionizing radiation curable resins. Examples of the thermosetting resins include an unsaturated polyester resin, an acrylic urethane resin, an epoxy-modified acrylic resin, an epoxy-modified unsaturated polyester resin, an alkyd resin, and a phenol resin. Examples of the thermoplastic resins include an acrylic ester resin, an acrylamide resin, a nitrocellulose resin, and a polystyrene resin. These resins may be used alone or as a copolymer of two or more. Further, one or two or more of the resins may be blended with various isocyanate resins, metal soap benzoyl peroxide such as cobalt naphthenate or zinc naphthenate, peroxides such as methyl ethyl ketone peroxide, or a thermosetting agent or ultraviolet hardening agent such as benzophenone, acetophenone, anthraquinone, naphthoquinone, azobisisobutyronitrile, or diphenyl sulfide. Examples of the ionizing radiation curable resins include an epoxy acrylate resin, an urethane acrylate resin, and an acrylic-modified polyester resin. Other monofunctional or polyfunctional monomers or oligomers may be included in the ionizing radiation-curable resin for the purpose of obtaining a cross-linked structure and adjusting viscosity.

The computer-generated hologram 1 is formed through a shaping process of pressing the mold surface of an original plate against the above resin material. Then, heating or ionizing radiation is applied for curing with an uncured thermosetting resin or ionizing radiation curable resin tightly adhered to the mold surface. After the resin material is cured, it is released from the mold surface of the original plate, whereby a fine relief structure of the computer-generated hologram 1 can be formed on one side of a layer composed of a cured transparent resin material. The resin material may be cured after being released from the mold surface.

Preferably, as the ionizing radiation curable resin, an ionizing radiation curable resin containing (1) isocyanates having three or more isocyanate groups in a molecule (2) polyfunctional (meta) acrylates having at least one hydroxyl group and at least two (meta) acryloyloxy groups in a molecule, or (3) urethane (meta) acrylate oligomer which is a reaction product of polyhydric alcohols having at least two hydroxyl groups in a molecule. Further, it is preferable to obtain the ionizing radiation curable resin by containing polyethylene wax, followed by coating, drying, and curing by ionizing radiation.

Examples of the ionizing radiation curable resin containing the urethane (meta) acrylate oligomer include a cured material of the ionizing radiation curable resin containing the urethane (meta) acrylate oligomer, in particular, the photocurable resin disclosed in JP 2001-329031 A. More specifically, MHX405 varnish (manufactured by Inktec Co., Ltd., product name of ionizing radiation-curable resin) can be exemplified.

The computer-generated hologram 1 may be formed as follows. That is, the above ionizing radiation curable resin is used as a main component, and a photopolymerization initiator, a plasticizer, a stabilizer, a surface acting agent, and the like are added thereto, followed by dispersion or dissolution in a solvent. Then, the resultant material is coated on the transparent substrate by a coating method such as roll coating, gravure coating, comma coating, or die coating, followed by drying. Then, after the shaping of the fine relief structure, ionizing radiation is performed for reaction (curing). The thickness of the computer-generated hologram layer is normally about 1 μm to 10 μm, preferably 2 μm to 5 μm.

The computer-generated hologram 1 may be provided with the reflective layer 3. The reflective layer 3 is formed as a thin film having a shape conforming to the relief surface. The configuration of the reflective layer 3 is not especially limited, but in order to reflect incident light, the reflective layer 3 needs to be formed as a thin film having a higher or lower refractive index than that of the computer-generated hologram 1.

The reflective layer 3 may be a metal luster reflective layer, such as a metal thin film formed by a vacuum deposition method, a sputtering method or an ion plating method that reflects visible light over almost the entire wavelength range thereof, or a transparent reflective layer that looks transparent depending on an observation direction or the like since it reflects only light of a specific wavelength; however, partially forming the metal luster reflective layer, thinly forming the metal luster reflective layer, or providing the transparent reflective layer is preferable since incident light from the object O can be observed through the thus-formed metal luster reflective layer or transparent reflective layer.

As a metal material for forming the reflective layer 3, a metal selected from a group consisting of Al, Cr, Ti, Fe, Co, Ni, Cu, Ag, Au, Ge, Mg, Sb, Pb, Cd, Bi, Sn, Se, In, Ga, or Rb, an oxide or a nitride thereof may be used, and among them, one or a combination of two or more may be selected for use. Among the above metal materials, Al, Cr, Ni, Ag, and Au are particularly preferable. The film thickness of the reflective layer 3 is preferably 1 nm to 10,000 nm and, more preferably, 2 nm to 1,000 nm.

In order to enhance transmittivity, it is more preferable to add a transparent reflective layer 3. When the transparent reflective layer 3 is provided on the relief surface of the computer-generated hologram 1, diffraction efficiency can be enhanced. The transparent reflective layer 3 is formed by a vacuum thin-film forming method, a sputtering method, an ion plating method or the like.

The transparent reflective layer 3 is almost colorless and transparent and has an optical refractive index different from that of the computer-generated hologram 1. Thus, in spite of absence of metal luster, the transparent reflective layer 3 makes brightness of a hologram or the like visible therethrough. As the reflection layer, thin films having a higher optical reflective index than that of the computer-generated hologram 1 and thin films having a lower optical reflective index than that of the same may be used. Examples of the former include ZnS, TiO₂, Al₂O₃, Sb₂S₃, SiO, SnO₂ and ITO. Examples of the latter include LiF, MgF₂ and AlF₃. Metal oxides or nitrides are preferred as the material of the reflective layer. More specifically, there may be listed oxides or nitrides of Be, Mg, Ca, Cr, Mn, Cu, Ag, Al, Sn, In, Te, Fe, Co, Zn, Ge, Pb, Cd, Bi, Se, Ga, Rb, Sb, Pb, Ni, Sr, Ba, La, Ce and Au, or a mixture of two or more of those. As in the case of metal thin layers, the transparent metal compound may be formed on the relief surface of the computer-generated hologram 1 by, for example, a vacuum thin-film forming method such as deposition, sputtering, ion plating and CVD, so as to have a thickness of about 1 nm to 10,000 nm, preferably of 2 nm to 1,000 nm.

As the low-diffraction-efficiency layer 4, a heat-sensitive adhesive that is melted or soften when heated to exhibit adhesion effect may be used. Examples of the heat-sensitive adhesive include a vinyl chloride resin, a vinyl acetate resin, a vinyl chloride-vinyl acetate copolymer resin, an acrylic resin, and a polyester resin.

Alternatively, as the low-diffraction-efficiency layer 4, an adhesive resin, such as a vinyl acetate resin, a vinyl acetate butyrate resin, a chloroprene rubber, an isoprene rubber, or an urethane resin may be used.

Alternatively, as the low-diffraction-efficiency layer 4, an adhesive layer having adhesion as well as a heat-adhesive property, such as an acrylic resin or a rubber resin having adhesion and heat-adhesive property or a mixture of an adhesive resin and a heat adhesive resin may be used.

The low-diffraction-efficiency layer 4 may be formed by dissolving or dispersing the above resin into a solvent, with additives added thereto as needed, followed by coating by a known coating method such as roll coating, gravure coating, or comma coating, and drying, whereby the low-diffraction-efficiency layer 4 having a thickness of 1 μm to 30 μm is obtained.

When the surface of a target object is smooth like a film sheet, a thickness of 1 μm to 5 μm is preferable. When the surface of a target object has a surface roughness of 30 μm or more, a thickness of 5 μm to 30 μm is preferable, and 20 μm to 30 μm is more preferable.

In the case of a transfer sheet configuration having a release layer, a transfer sheet is put on a given position of the surface of a target object, followed by predetermined heating and pressurizing. Thereafter, a transparent substrate is released to transfer the computer-generated hologram 1 in a desired shape, thereby achieving transfer of the screen 10 onto the window W illustrated in FIG. 1.

In the present embodiment, it is preferable that an ionizing radiation curable resin having a refractive index of 1.49 is used as the computer-generated hologram 1, that polyethylene terephthalate having a thickness of 50 μm is used as the substrate 2, that an acrylic adhesive having a refractive index of 1.47 is used as the low-diffraction-efficiency layer 4, and that glass is used as an adherend.

The refractive index of the adhesive layer as the low-diffraction-efficiency layer 4 is set to 1.46 to 1.49. Thus, the blending amount of inorganic oxide particles is preferably 50 wt. % to 300 wt. % relative to 100 wt. % of a curable compound, preferably, 100 wt. % to 200 wt. %, and more preferably, 100 wt. % to 150 wt. %.

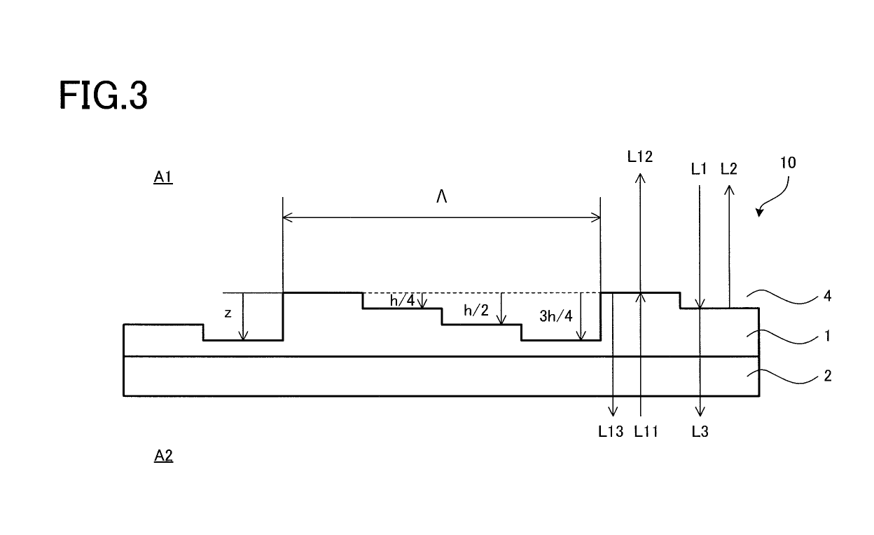

FIG. 3 is a schematic view of a screen 10 according to a first embodiment.

The screen 10 according to the first embodiment uses the low-diffraction-efficiency layer 4 as an air layer and does not use the reflective layer 3. Thus, as illustrated in FIG. 3, a first incident light L1 corresponding to an incident light emitted from the projector P illustrated in FIG. 1 is reflected at an interface between the air layer of a region A1 and the computer-generated hologram 1 to be directed to the observer E illustrated in FIG. 1 as a reflected light L2. A second incident light L11 corresponding to an object light Lo1 of an object O illustrated in FIG. 1 is transmitted through the substrate 2 and the computer-generated hologram 1 from a region A2 to be directed to the observer E illustrated in FIG. 1 as a transmitted light L12.

The low-diffraction-efficiency layer 4 in the first embodiment is the air layer, so that a refractive index n₁ thereof is 1.0. As the computer-generated hologram 1, an ultraviolet curable resin having a refractive index n₂ of 1.49 is used. As the substrate 2, polyethylene terephthalate is used. A depth z of the relief in each integration section Λ of the computer-generated hologram 1 is: 0 from 0 to Λ/4; h/4 from Λ/4 to Λ/2; h/2 from Λ/2 to 3Λ/4; and 3h/4 from 3Λ/4 to Λ.

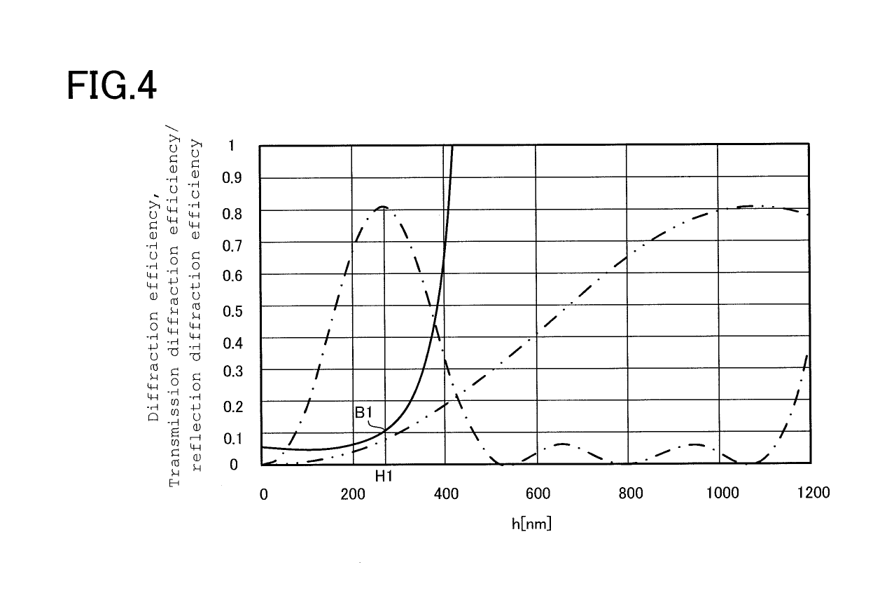

FIG. 4 illustrates the diffraction efficiency of the screen 10 according to the first embodiment.

The dashed dotted line in FIG. 4 denotes diffraction efficiency for reflected light, and the dashed double-dotted line denotes diffraction efficiency for transmitted light. The continuous line denotes the ratio of the diffraction efficiency for transmitted light to the diffraction efficiency for reflected light. The first incident light L1 and the second incident light L11 each have a wavelength of 532 nm.

In the first embodiment, the reflection diffraction efficiency is preferably set to a value higher than the transmission diffraction efficiency in order to achieve high transparency and clear reflection of a projected image. In particular, the ratio of the diffraction efficiency for transmitted light to the diffraction efficiency for reflected light is preferably less than 0.2. More preferably, the ratio of the diffraction efficiency for transmitted light to the diffraction efficiency for reflected light is less than 0.1, and the reflection diffraction efficiency is equal to or more than 60%. The measurement of the diffraction efficiency is performed according to “5.5.3 method of measuring relative diffraction efficiency” of JIS Z 8791 (Methods of measuring diffraction efficiency and associated optical characteristics of hologram).

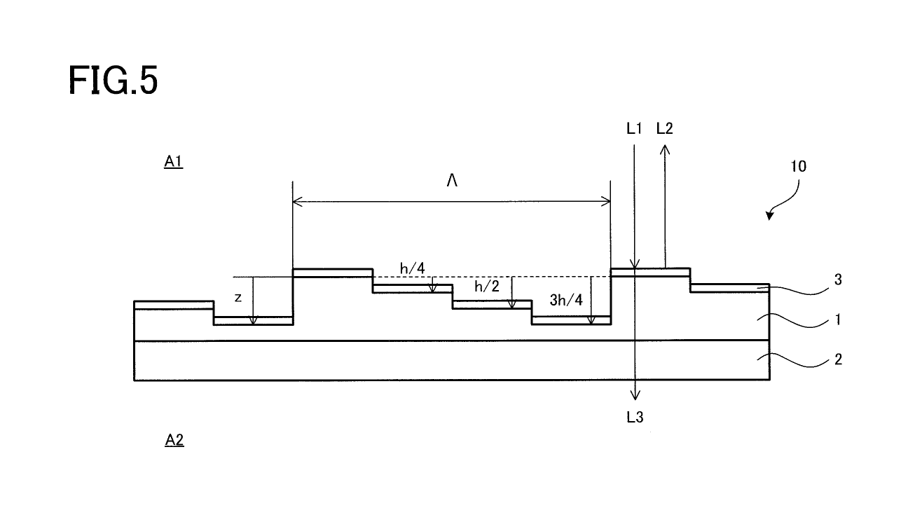

FIG. 5 is a schematic view of a screen 10 according to a second embodiment.

The screen 10 according to the second embodiment has a configuration in which the reflective layer 3 is added to the screen 10 according to the first embodiment. As illustrated in FIG. 5, a first incident light L1 corresponding to an incident light emitted from the projector P illustrated in FIG. 1 enters the screen 10 from an air layer of a region A1, and then reflected at the reflective layer 3 to be directed to the observer E illustrated in FIG. 1 as a reflected light L2. The refractive index n₃ of the reflective layer 3 is 2.37.

When the reflective layer 3 is formed by depositing a transparent layer having a diffractive index higher than that of the computer-generated hologram 1, the reflectance thereof is enhanced, thereby enabling a projector image to be observed with higher brightness.

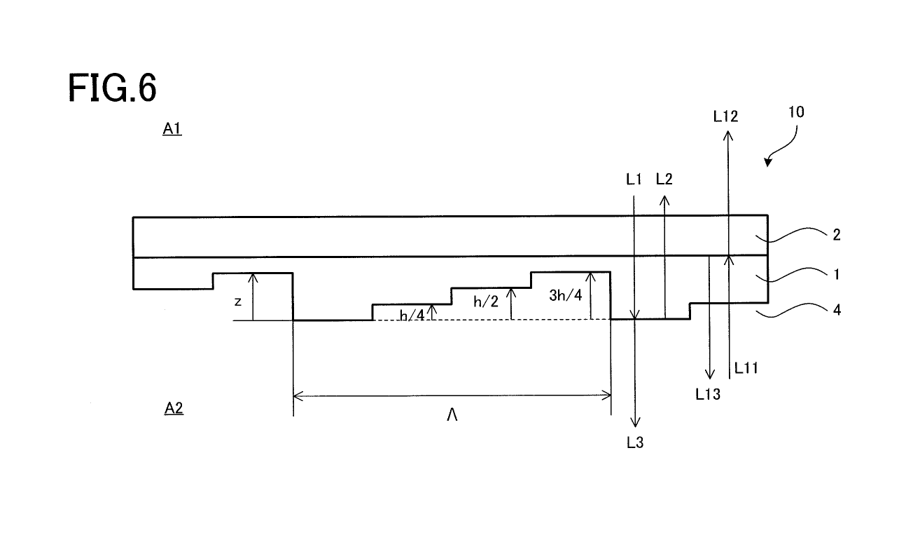

FIG. 6 is a schematic view of a screen 10 according to a third embodiment.

The screen 10 according to the third embodiment is disposed reversely with respect to the light traveling direction. Thus, as illustrated in FIG. 6, a first incident light L1 corresponding to an incident light emitted from the projector P illustrated in FIG. 1 enters the substrate 2 from a region A1, transmitted through the computer-generated hologram 1, reflected at an interface between the computer-generated hologram 1 and an air layer as the low-diffraction-efficiency layer 4, and transmitted through the computer-generated hologram 1 and substrate 2 as a reflected light L2 to be directed to the observer E illustrated in FIG. 1 in the region A1. A second incident light L11 corresponding to an object light Lot of an object O illustrated in FIG. 1 is transmitted through the computer-generated hologram 1 and substrate 2 from a region A2 to be directed to the observer E illustrated in FIG. 1 as a transmitted light L12.

The low-diffraction-efficiency layer 4 is the air layer, so that a refractive index n₁ thereof is 1.0. As the computer-generated hologram 1, an ultraviolet curable resin having a refractive index n₂ of 1.49 is used. As the substrate 2, polyethylene terephthalate is used. A depth z of the relief in each integration section of the computer-generated hologram 1 is: 0 from 0 to Λ/4; h/4 from Λ/4 to Λ/2; h/2 from Λ/2 to 3Λ/4; and 3h/4 from 3Λ/4 to Λ.

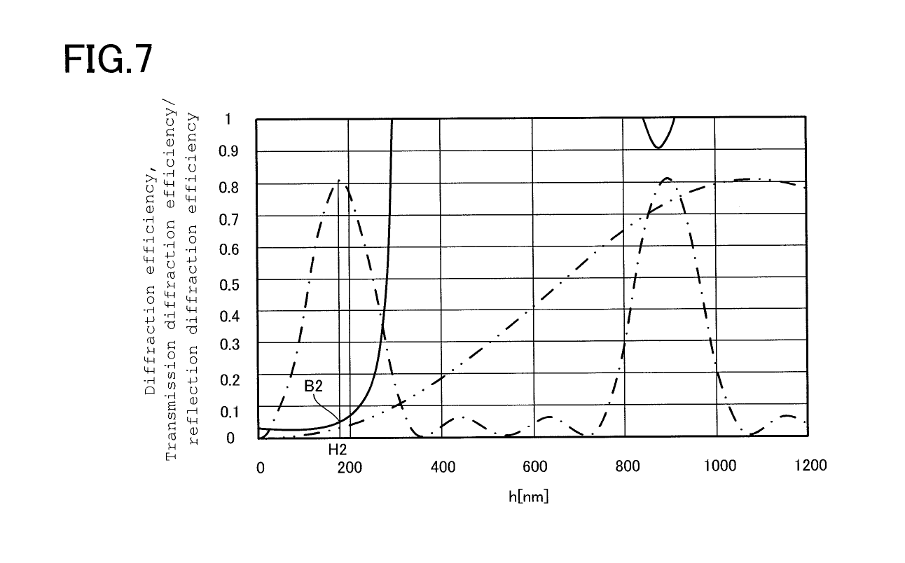

FIG. 7 illustrates the diffraction efficiency of a screen 10 according to the third embodiment.

The dashed dotted line in FIG. 7 denotes diffraction efficiency for reflected light, and the dashed double-dotted line denotes diffraction efficiency for transmitted light. The continuous line denotes the ratio of the diffraction efficiency for transmitted light to the diffraction efficiency for reflected light. The first incident light L1 and second incident light L11 each have a wavelength of 532 nm.

In the third embodiment, the reflection diffraction efficiency is preferably set to a value higher than the transmission diffraction efficiency in order to achieve high transparency and clear reflection of a projected image. In particular, the ratio of the diffraction efficiency for transmitted light to the diffraction efficiency for reflected light is preferably less than 0.2. More preferably, the ratio of the diffraction efficiency for transmitted light to the diffraction efficiency for reflected light is less than 0.1, and the reflection diffraction efficiency is equal to or more than 60%.

Further, as can be seen from a comparison between FIG. 7 and FIG. 4, a value B2 (FIG. 7) of the ratio of the diffraction efficiency for transmitted light to the diffraction efficiency for reflected light at a relief depth H2 at which the reflection diffraction efficiency of the screen 10 according to the third embodiment projected with a projector image from the substrate 2 side becomes maximum is less than a value B1 of the ratio of the diffraction efficiency for transmitted light to the diffraction efficiency for reflected light at a relief depth H1 at which the reflection diffraction efficiency of the screen 10 according to the first embodiment projected with a projector image from the computer-generated hologram 1 side becomes maximum, thereby achieving high transparency and clear reflection of a projected image.

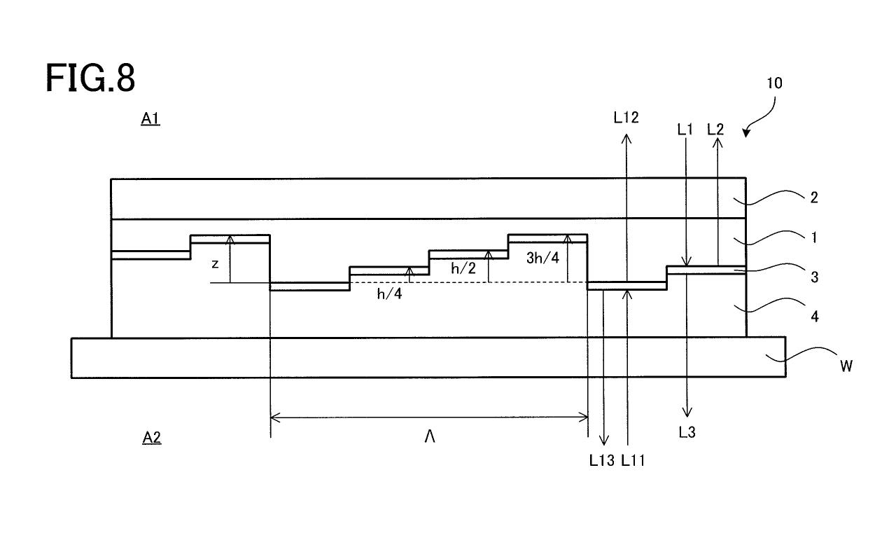

FIG. 8 is a schematic view of a screen 10 according to a fourth embodiment.

The screen 10 according to the fourth embodiment has a configuration in which the reflective layer 3 is added to the screen 10 according to the third embodiment and is stuck to the window W by using an adhesive layer as the low-diffraction-efficiency layer 4. Thus, as illustrated in FIG. 8, a first incident light L1 corresponding to an incident light emitted from the projector P illustrated in FIG. 1 enters the substrate 2 from a region A1, is transmitted through the computer-generated hologram 1, reflected at the reflective layer 3, transmitted through the computer-generated hologram 1 and substrate 2 as a reflected light L2, and emitted to the region A1 to be directed to the observer E illustrated in FIG. 1. A second incident light L11 corresponding to an object light Lot of an object O illustrated in FIG. 1 is transmitted through the window W, low-diffraction-efficiency layer 4, reflective layer 3, computer-generated hologram 1, and substrate 2 from a region A2, and emitted to the region A1 as a transmitted light L12 to be directed to the observer E illustrated in FIG. 1.

As the low-diffraction-efficiency layer 4 of the screen 10 according to the fourth embodiment, an acrylic adhesive layer having a refractive index n₁ of 1.47 is used. As the computer-generated hologram 1, an ultraviolet curable resin having a refractive index n₂ of 1.49 is used. As the reflective layer, zinc sulfide having a refractive index n₃ of 2.37 is used. As the substrate 2, polyethylene terephthalate is used. A depth z of the relief in each integration section of the computer-generated hologram 1 is: 0 from 0 to Λ/4; h/4 from Λ/4 to Λ/2; h/2 from Λ/2 to 3Λ/4; and 3h/4 from 3Λ/4 to Λ.

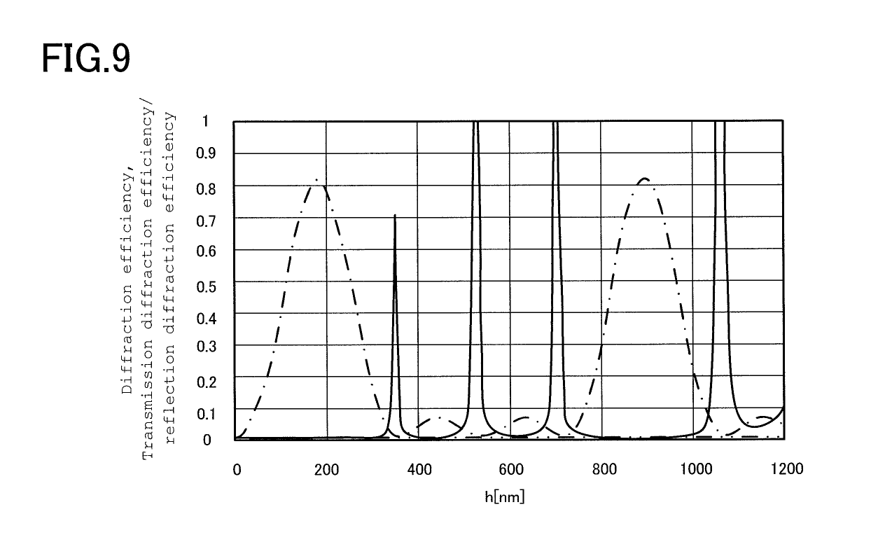

FIG. 9 illustrates an example of the diffraction efficiency of a screen 10 according to the fourth embodiment.

The dashed dotted line in FIG. 9 denotes diffraction efficiency for reflected light, and the dashed double-dotted line denotes diffraction efficiency for transmitted light. The continuous line denotes the ratio of the diffraction efficiency for transmitted light to the diffraction efficiency for reflected light. The first incident light L1 and the second incident light L11 each have a wavelength of 532 nm.

In the fourth embodiment, the reflection diffraction efficiency is preferably set to a value higher than the transmission diffraction efficiency in order to achieve high transparency and clear reflection of a projected image. In particular, the relief of the computer-generated hologram 1 is filled with the adhesive layer having the index n₁ of 1.47 close to the refractive index n₂ of 1.49 of the computer-generated hologram 1, thus significantly reducing the transmission diffraction efficiency. More preferably, when the reflection diffraction efficiency is equal to or more than 0.1, the ratio of the transmission diffraction efficiency to the reflection diffraction efficiency becomes less than 0.1.

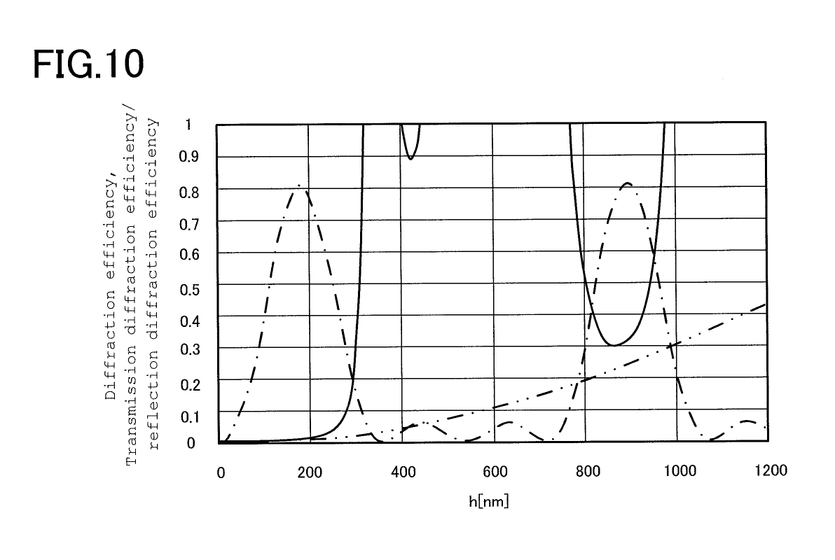

FIG. 10 illustrates another example of the diffraction efficiency of a screen 10 according to the fourth embodiment.

The dashed dotted line in FIG. 10 denotes diffraction efficiency for reflected light, and the dashed double-dotted line denotes diffraction efficiency for transmitted light. The continuous line denotes the ratio of the diffraction efficiency for transmitted light to the diffraction efficiency for reflected light. The first incident light L1 and the second incident light L11 each have a wavelength of 532 nm.

The another example of the diffraction efficiency of the screen 10 according to the fourth embodiment illustrated in FIG. 10 is a value obtained when the difference between the refractive index of the computer-generated hologram 1 and that of the low-diffraction-efficiency layer 4 is set to 0.25. That is, FIG. 10 illustrates the diffraction efficiency of the screen 10 of the fourth embodiment when |refractive index of adhesive layer−refractive index of computer-generated hologram 1|=0.25 is satisfied. The |refractive index of adhesive layer−refractive index of computer-generated hologram 1| is preferably equal to or less than 0.25. Note that “∥” is a sign indicating an absolute value.

In this example, the relief of the computer-generated hologram 1 is filled with the adhesive layer having a difference of 0.25 in refractive index from the computer-generated hologram 1. Thus, when the reflection diffraction efficiency is equal to or more than 0.2 in a range of relief depth h<300 nm, the ratio of the transmission diffraction efficiency to the reflection diffraction efficiency becomes less than 0.2. Thus, even when there occurs a slight shift from a position at which the reflection diffraction efficiency is maximum, high transparency and clear reflection of a projected image can be achieved.

The following describes a case where directivity is imparted to the screen 10 of the present embodiment so as to enable white light observation with high brightness within a given white light observation region.

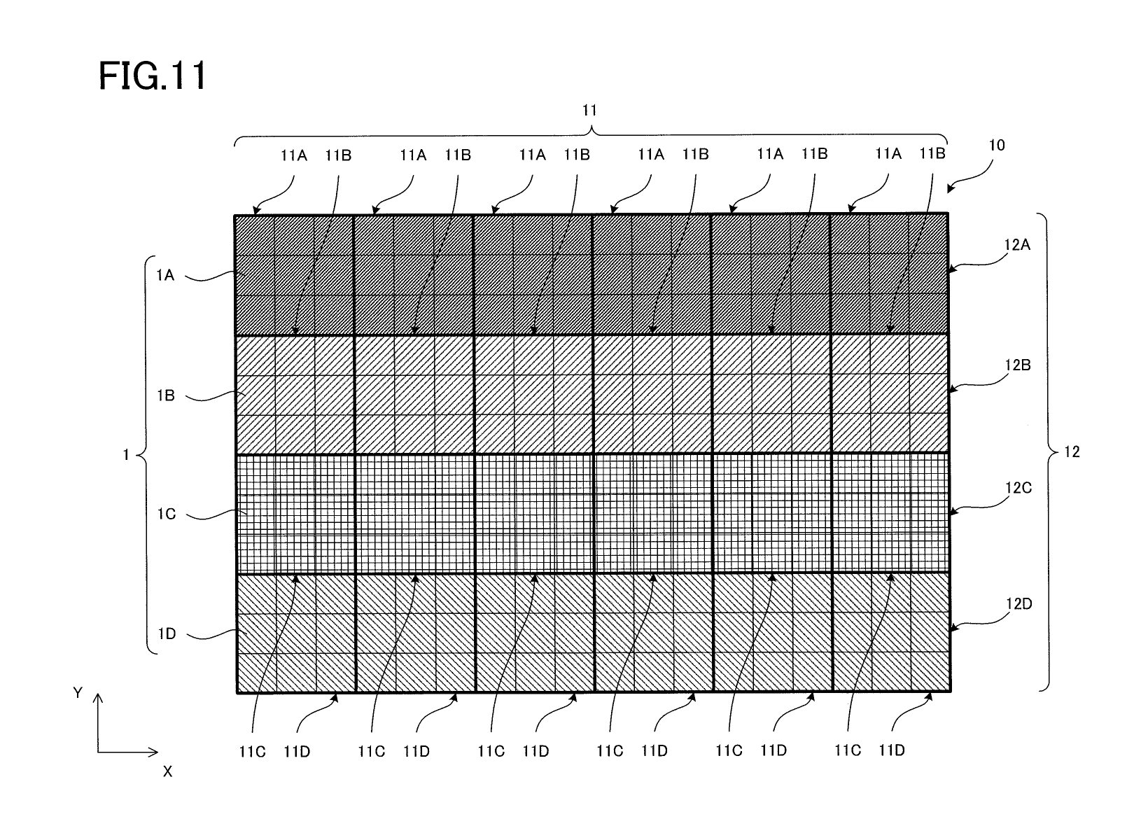

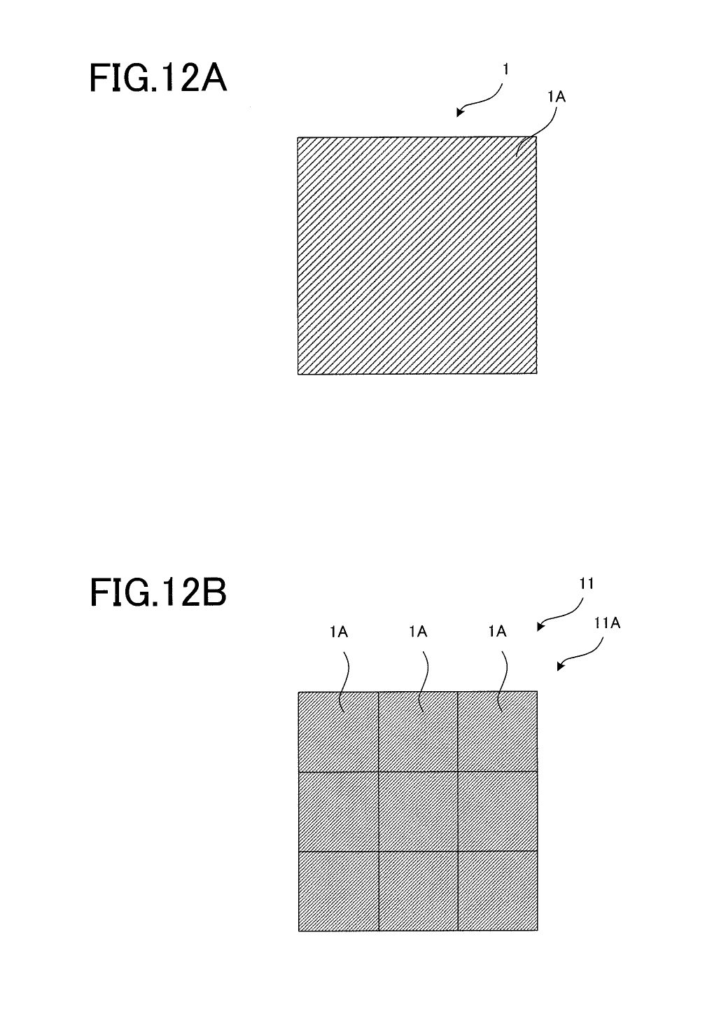

FIG. 11 illustrates a projector screen of a first example according to the present embodiment. FIGS. 12A and 12B illustrate an elemental hologram group of the projector screen of the first example according to the present embodiment.

As illustrated in FIG. 11, the screen 10 according to the present embodiment is formed by arranging a plurality of elemental hologram groups 11 in a two-dimensional plane. Further, as illustrated in FIGS. 12A and 12B, each elemental hologram group 11 is formed by arranging a plurality of elemental holograms 1 in a two-dimensional plane. That is, the screen 10 is constituted of a set of divided elemental hologram groups 11, and each elemental hologram group 11 is constituted of a set of divided elemental holograms 1. The diffusion angle of the elemental hologram 1 is set to a value smaller than a value at which isotropic scattering occurs. Accordingly, the diffusion angle of the screen 10 as an aggregation of the elemental holograms 1 is set smaller than a value at which isotropic scattering occurs. The two-dimensional plane is preferably constituted of a first direction X and a second direction Y perpendicular to the first direction X. In the present embodiment, the horizontal direction is set as the first direction X, and the vertical direction is set as the second direction Y.

The elemental hologram 1 is constituted of a computer-generated hologram that forms the elemental hologram group 11. As illustrated in FIG. 12B, one elemental hologram group 11 is formed by arranging the elemental holograms 1 in a 3×3 matrix. One elemental hologram 1 of the first example has a square shape. One elemental hologram group 11 also has a square shape. The screen 10 has a horizontally-long rectangular shape.

The screen 10 of the first example is formed by two-dimensionally arranging the elemental hologram groups 11 in a 4×6 matrix. In the screen 10 of the first example, the elemental hologram groups 11 having the same specification are arranged in the horizontal direction as the first direction. For example, in FIG. 11, six first elemental hologram groups 11A as a first horizontal block 12A are arranged in the uppermost row, six second elemental hologram groups 11B as a second horizontal block 12B are arranged in the second row from above, six third elemental hologram groups 11C as a third horizontal block 12C are arranged in the third row from above, and six fourth elemental hologram groups 11D as a fourth horizontal block 12D are arranged in the fourth row from above. The blocks 12A, 12B, 12C, and 12D are arranged in parallel in the vertical direction Y.

The shape of the elemental hologram 1 is not limited to a square shape, but may be a rectangular or triangular shape. The adjacent elemental holograms 1 are not necessarily tightly adhered to each other, but may be disposed with a predetermined gap interposed therebetween as long as they are substantially close to each other. The elemental hologram group 11 may be formed corresponding to the shape of the elemental hologram 1. The number of the elemental holograms 1 constituting the elemental hologram group 11, and the number of elemental hologram groups 11 constituting the screen 10 may be arbitrary.

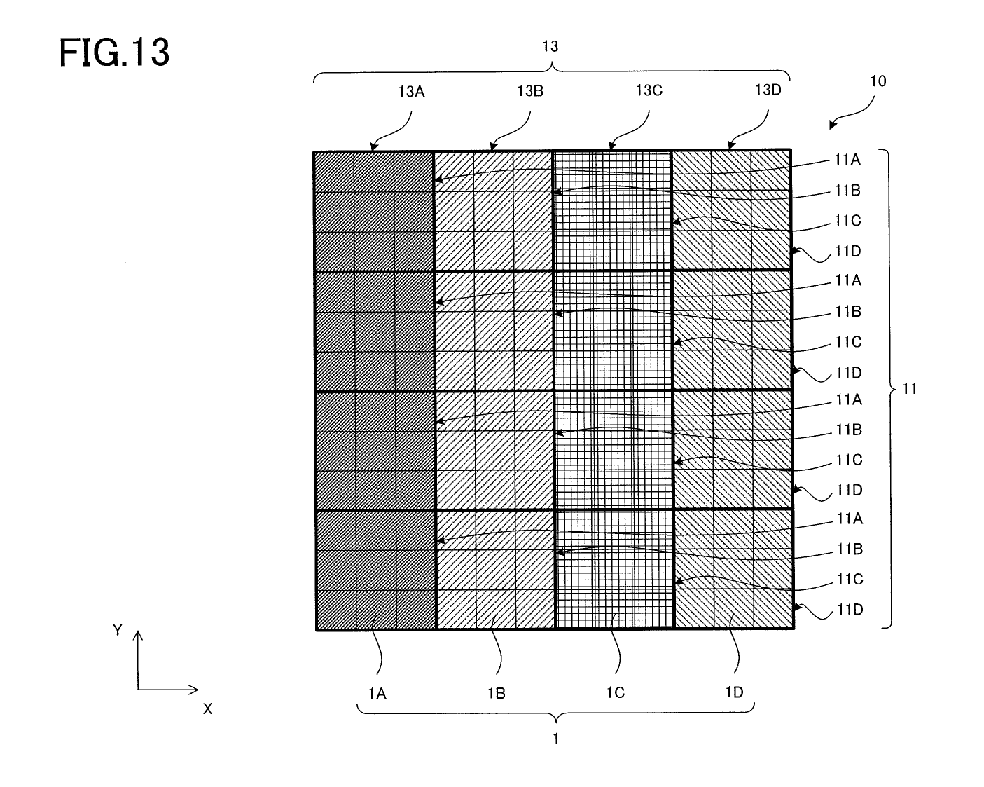

FIG. 13 illustrates a projector screen of a second example according to the present embodiment.

One elemental hologram. 1 of the second example has a square shape. One elemental hologram group 11 also has a square shape. The screen 10 also has a square shape.

The screen 10 of the second example is formed by two-dimensionally arranging the elemental hologram groups 11 in a 4×4 matrix. In the screen 10 of the second example, the elemental hologram groups 11 having the same specification are arranged in the vertical direction Y as the second direction. For example, in FIG. 13, four first elemental hologram groups 11A as a first vertical block 13A are arranged in the leftmost column, four second elemental hologram groups 113 as a second vertical block 13B are arranged in the second column from the left, four third elemental hologram groups 11C as a third vertical block 13C are arranged in the third column from the left, and four fourth elemental hologram groups 11D as a fourth vertical block 13D are arranged in the rightmost column. The blocks 13A, 13B, 13C, and 13D are arranged in parallel in the horizontal direction X.

The shape of the elemental hologram 1 is not limited to a square shape, but may be a rectangular or triangular shape. The adjacent elemental holograms 1 are not necessarily tightly adhered to each other, but may be disposed with a predetermined gap interposed therebetween as long as they are substantially close to each other. The elemental hologram group 11 may be formed corresponding to the shape of the elemental hologram 1. The number of the elemental holograms 1 constituting the elemental hologram group 11, and the number of elemental hologram groups 11 constituting the screen 10 may be arbitrary.

As described in the first example illustrated in FIG. 11 and the second example illustrated in FIG. 13, the computer-generated hologram includes the same elemental hologram 1 on a block-by-block basis. That is, the elemental hologram groups 11 having the same specification are arranged in the horizontal direction or vertical direction, so that multi-layout can be achieved even in a small original plate, allowing screen size to be easily increased. For example, multiple elemental hologram groups 11 can be laid out in the horizontal direction as the first direction in the first example, and multiple elemental hologram groups 11 can be laid out in the vertical direction as the second direction in the second example. The specification of the computer-generated hologram includes a shape, a thickness, a grating interval, a material, and the like.

As described above, the elemental hologram groups 11 having the same specification are arranged in the horizontal direction in the first example, and the elemental hologram groups 11 having the same specification are arranged in the vertical direction in the second example. Alternatively, a configuration in which all the elemental hologram groups 11 have different specifications, a configuration in which all the elemental hologram groups 11 have the same specification, and a configuration in which some elemental hologram groups 11 have the same specification and the others have different specifications may be adopted.

Hereinafter, for easy understanding, a transmissive type elemental hologram 1 will be described. However, the following description may be applied to a reflective type elemental hologram 1 as exemplified in the present embodiment.

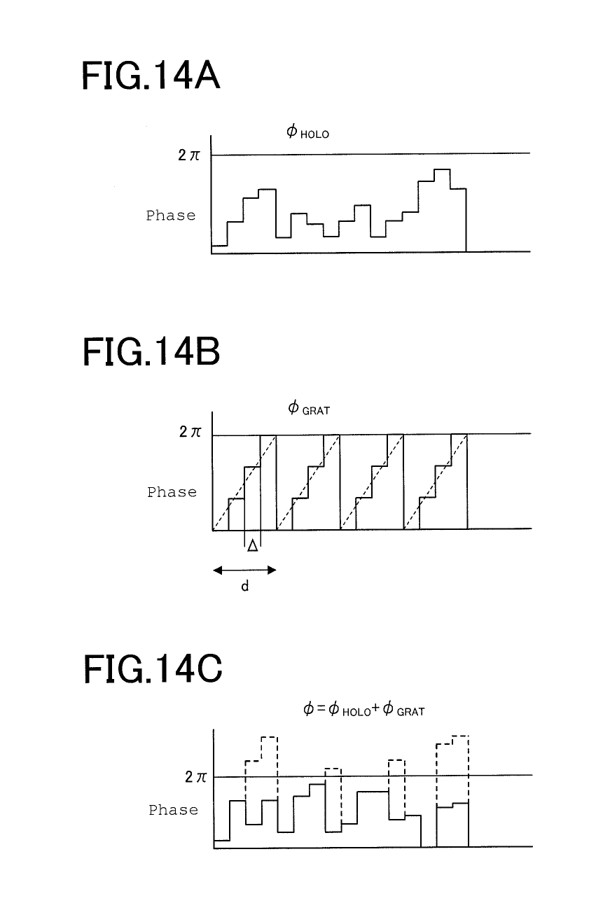

FIGS. 14A to 14C illustrate an example of the phase distribution of the computer-generated hologram used in the projector screen according to the present embodiment.

The elemental hologram 1 constituted of the computer-generated hologram is an aggregation of minute cells two-dimensionally disposed in an array. Each cell has an optical path length that gives a unique phase to reflected light or incident light and has a phase distribution obtained by adding first and second phase distributions. The first phase distribution is a phase distribution that substantially diffracts a light beam vertically incident on the cell within a given observation region and does not diffract the same outside the observation range. The second phase distribution is a phase distribution that vertically emits a light beam incident on the cell obliquely at a given incident angle.

More specifically, the first phase distribution is a phase distribution of the computer-generated hologram that diffracts light only to a given observation range when the hologram plane is illuminated with parallel light. For example, the first phase distribution may be such a phase distribution φ_{HOLO} as illustrated in FIG. 14A.

The second phase distribution is a phase distribution of a phase diffraction grating that diffracts light incident from behind at an incident angle θ in the forward direction. In other words, this is a phase distribution φ_{GRAT} obtained by approximating such a phase distribution as indicated by dashed lines in FIG. 14B in the form of a digital step-formed function.

The phase distribution obtained by the addition of two such phase distributions φ_{HOLO} and _{GRAT} provides the phase distribution φ of the computer-generated hologram described in Patent Document 1 and shown in FIG. 14C, and the computer-generated hologram having this phase distribution φ acts to diffract the light obliquely entering from behind at the incident angle θ toward a given observation range in the forward direction.

Generally, a computer-generated hologram is obtained as follows. Now consider a certain hologram. When the hologram plane is vertically illuminated with parallel light at a reconstruction distance much larger than the size of the hologram, a diffraction light obtained at a reconstructed image plane is represented in terms of an amplitude distribution at the hologram plane and the Fourier transform of a phase distribution (Fraunhofer diffraction).

To impart a given diffraction light to the reconstructed image plane, a computer-generated hologram positioned at the hologram plane has so far been found by a method wherein the Fourier transform and inverse Fourier transform are alternately repeated between the hologram plane and the reconstructed image plane with the application of constraints. This method is known as the Gerchberg-Saxton iterative algorithm method.

Here, assuming that h(x, y) represents the distribution of light at the hologram plane and f (u, v) represents the distribution of light at the reconstructed image plane, these distributions of light are represented by the following expressions (5) and (6).

h(x,y)=A_{HOLO}(x,y)exp(i (x,y)) (5)

f(u,v)=A_{IMG}(u,v)exp(iφ_{IMG}(u,v)) (6)

In the above expressions, A_{HOLO}(x, y) is an amplitude distribution at the hologram plane, _{HOLO}(x, y) is a phase distribution at the hologram plane, A_{IMG}(u, v) is an amplitude distribution at the reconstructed image plane, and φ_{IMG}(u, v) is a phase distribution at the reconstructed image plane.

The above Fourier transform and inverse Fourier transform are given by the following expressions (7) and (8).

$$\begin{matrix}[ Numeral 3 ] & \\ f ( u , v ) = \int {\int }_{- ∞}^{∞} h ( x , y ) exp \{ - i ( ux + vy ) \} dxdy & ( 7 ) \\ h ( x , y ) = \int {\int }_{- ∞}^{∞} f ( x , y ) exp \{ i ( ux + vy ) \} dudv & ( 8 )\end{matrix}$$

For a better understanding of the following discussions, the amplitude distribution A_{HOLO}(x, y) at the hologram plane is represented by A_{HOLO}, the phase distribution φ_{HOLO}(x, y) at the hologram plane by (I) HOLO r the amplitude distribution A_{IMG}(u, v) at the reconstruction plane by A_{IMG}, and the phase distribution φ_{IMG}(u, v) at the reconstruction plane by φ_{IMG}.

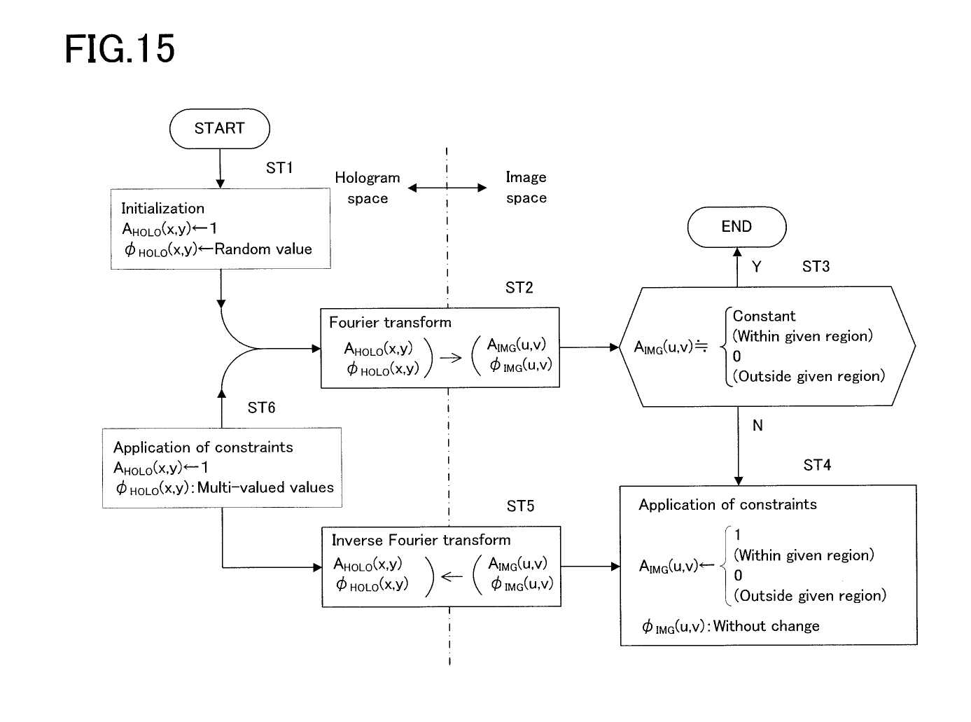

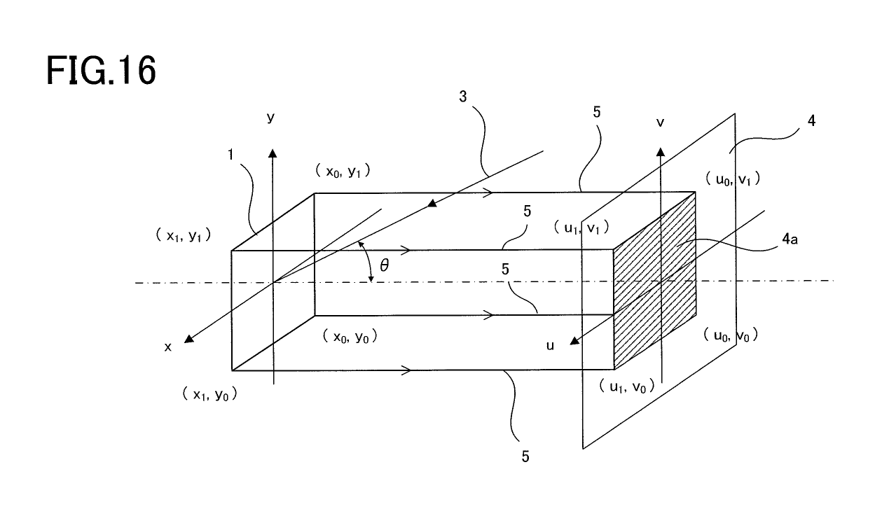

FIG. 15 is a flowchart illustrating calculation steps for the computer-generated hologram used in the projector screen according to the present embodiment. FIG. 16 illustrates a range of exit light with respect to light incident on the computer-generated hologram used in the projector screen according to the present embodiment.

FIG. 15 is a flowchart to this end. At step 1, the hologram amplitude A_{HOLO} and hologram phase φ_{HOLO} are initialized to 1 and a random value, respectively, at hologram plane regions x0≦x≦x1 and y0≦y≦y1 in FIG. 16, and at step 2, the thus initialized values are subject to the Fourier transform represented by the above expression (7). If, at step (3), the amplitude A_{IMG} at the reconstructed image plane, obtained by the Fourier transform, has a substantially constant value within given regions, e.g., u0≦u≦u1 and v0≦v≦≦v1, and becomes substantially zero within other regions, the amplitude and phase initialized at step 1 provide a desired computer-generated hologram.

If, at step 3, such conditions are not satisfied, constraints are applied at step 4. For example, a value of 1 is imparted to the amplitude A_{IMG} at the reconstructed image plane within the given regions and a value of 0 is applied within other regions, while the phase φ_{IMG} at the reconstructed image plane is kept intact. After such constraints are applied, the inverse Fourier transform represented by the above expression (8) is applied at step 5. At step 6, constraints are applied to the value at the hologram plane, obtained by the inverse Fourier transform, to take the amplitude A_{HOLO} as 1 and allow the phase φ_{HOLO} to have multi-valued values (bring the original function approximate to a digital step-formed function (quantization)). It is noted that when the phase φ_{HOLO} is allowed to have a continuous value, such a multi-valued phase is not necessarily required.

Then, the value is subjected to the Fourier transform at step 2. If, at step 3, the amplitude A_{IMG} at the reconstructed image plane, obtained by the Fourier transform, has a substantially constant value within the given regions, e.g., u0≦u≦u1 and v0≦v≦v1, and becomes substantially zero within other regions, the amplitude and phase, to which the constraints are applied at step 6, provide a desired computer-generated hologram. If, at step 3, such conditions are not satisfied, the loop of steps 4→5→6→2→3 is repeated until the conditions for step 3 are satisfied (or converged), so that the final desired computer-generated hologram can be obtained.

For an estimating function for determining that the amplitude A_{IMG} at the reconstructed image plane is converged to a substantial given value at step 3, for example, the following expression (9) is used. However, the Σ (sum) with respect to u and v means the sum of the values at u0≦u≦u1 and v0≦v≦v1 for the cells in the hologram, and <A_{IMG}(u, v)> represents an ideal amplitude in the cell. For example, when this estimating function is equal to or less than 0.01, the function is assumed to be converged. Alternatively, the following expression (10) using a difference between the previous amplitude value and the present amplitude value in the repetition of the calculation loop may be used as the estimating function. Here, A_{IMGi-1} is the previous amplitude value and A_{IMGi} is the present amplitude value.

$$\begin{matrix} [ Numeral 4 ] & \\ ( evaluating function ) = 1 / {N}^{2} \times {\sum }_{u , y} \vert {A}_{IMG} ( u , v ) - 〈 {A}_{IMG} ( u , v ) 〉 \vert & ( 9 ) \\ ( evaluating function ) = 1 / {N}^{2} \times {\sum }_{u , y} \vert {A}_{IMGi} ( u , v ) - {A}_{IMGi - 1} ( u , v ) \vert & ( 10 )\end{matrix}$$

From the thus obtained phase distribution, the depth distribution of an actual hologram is calculated. Regarding how to calculate the depth distribution, there is a difference between a reflective type hologram and a transmissive type hologram. When the hologram is of the reflective type, expression (11a) is used and when the hologram is of the transmissive type, expression (11b) is used. In other words, φ of FIG. 14C (φ(x, y) in the following expressions) is transformed to a depth D of the computer-generated hologram (D(x, y) in the following expressions).

D(x,y)=λφ(x,y)/(4πn) (11a)

D(x,y)=λφ(x,y)/{2π(n₁−n₀)} (11b)

Here (x, y) is the coordinates indicative of a position on the hologram plane, λ is a reference wavelength, n is the refractive index of the material forming the light incident side of the reflection surface, and n₁ and n₀ are the refractive indices of the two materials forming the transmissive type hologram provided that n₁>n₀.

As will be also explained later, a relief pattern having a depth D (x, y) calculated from the above expressions (11a) and (11b) for each minute cell having a horizontal x vertical size Δ is formed on the surface of a hologram-forming resin layer, with a given reflective layer laminated thereon. The resultant hologram can be used as a hologram with enhanced effect. This Δ, for example, is equivalent to the feed pitch of pattern exposure light.

The phase distribution of the computer-generated hologram 1 may be calculated not only by the above methods known so far in the art but also by other methods, e.g., one described in JP 47-6591 A. If required, the calculated phase distribution may be optimized by suitable methods such as a genetic algorithm or a simulated annealing method.

The following describes a computer-generated hologram which can be seen in white in a desired observation range. The computer-generated hologram which can be seen in white in a desired observation range is designed to diffuse light of a given standard wavelength incident thereon at a given incident angle in a specific angle range, wherein in a range of wavelengths including the standard wavelength wherein zero-order transmission light or zero-order reflection light incident on the computer-generated hologram at the incident angle is seen in white by additive color mixing, the maximum diffraction angle of incident light of the minimum wavelength in the range and incident at the incident angle is larger than the minimum diffraction angle of incident light of the maximum wavelength in the range and incident at the incident angle.

For the sake of simplicity, description will be given of a transmissive type computer-generated hologram. However, it is noted that the present invention can also be applied to the reflective type computer-generated hologram 1 as exemplified in the present embodiment.

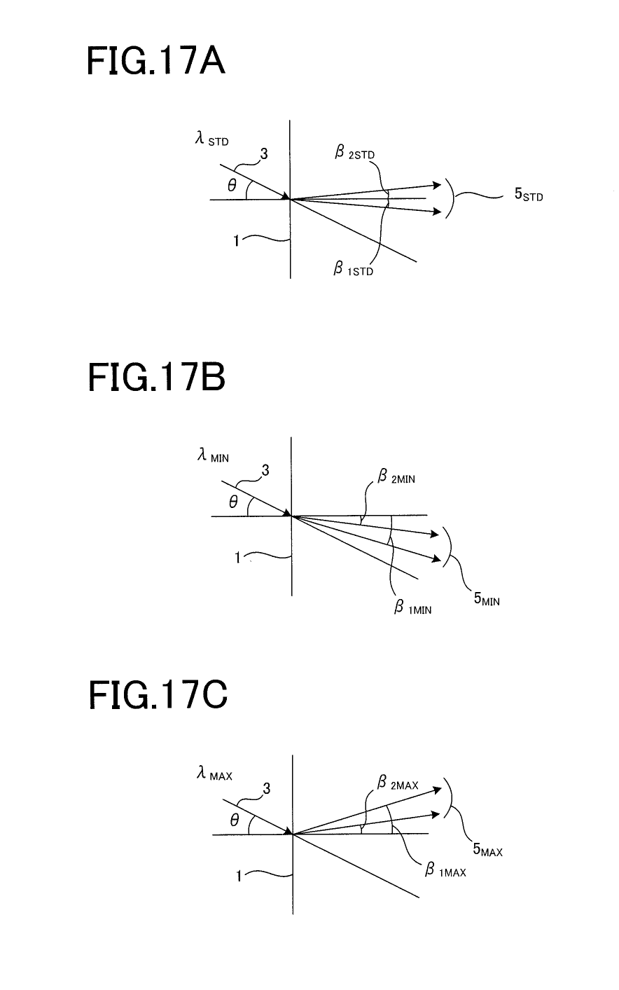

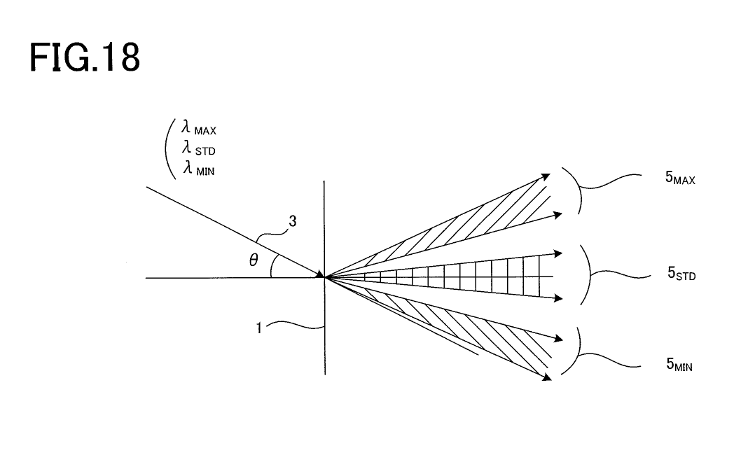

FIGS. 17A to 17C conceptually illustrate how a narrow observation region set for the computer-generated hologram 1 changes with wavelengths. FIG. 18 illustrates diffraction of each wavelength when the observation region set for the computer-generated hologram used in the projector screen of the first example according to the present embodiment is narrow.

Here, assume that the standard wavelength λ_{STD} of illumination light is between the minimum wavelength λ_{MIN} and the maximum wavelength λ_{MAX}. The computer-generated hologram 1 is designed with respect to the standard wavelength λ_{STD} As illustrated in FIG. 17A, consider a case where illumination light 3 entering the computer-generated hologram 1 at the standard wavelength λ_{STD} and a certain oblique angle θ (which is an angle from the normal to the hologram 1 with the proviso that the counterclockwise angle is positive) spreads as diffraction light 5_{STD} in an angle range of β_{1STD} to β_{2STD} in the vicinity of the front. Numerical subscripts 1 and 2 indicate the minimum diffraction angle and the maximum diffraction angle, respectively. It is appreciated that the minimum diffraction angle is the diffraction angle of diffraction light that makes the minimum angle with zero-order transmission light and the maximum diffraction angle is the diffraction angle of diffraction light that makes the maximum angle with the zero-order transmission light. As illumination light 3 of the minimum wavelength λ_{MIN} enters the hologram 1 at the same oblique angle θ, an observation region (the angle range of β_{1MIN} to β_{2MIN}) to receive diffraction light 5_{MIN} is shifted to a lower side (the zero-order transmission light side) as compared with the incidence of the standard wavelength λ_{2STD}, as shown in FIG. 17B, because the computer-generated hologram 1 is taken as being a cluster of phase diffraction gratings. As illumination light 3 of the maximum wavelength λ_{MAX} enters the hologram 1 at the same incident angle θ, on the other hand, an observation region (the angle range of β_{1MAX} to β_{MAX}) to receive diffraction light 5_{MAX} is shifted to an upper side (the side opposite to the zero-order transmission light side) as compared with the incidence of the standard wavelength λ_{STD}, as shown in FIG. 17C.

It is here noted that such a distribution of diffraction light as described above is found within a plane including the normal to the computer-generated hologram 1 and the illumination light 3. Within a plane including the normal to the computer-generated hologram 1 and perpendicular to that plane, however, diffraction light is distributed on both sides of the illumination light 3.

In the absence of any region where all diffraction light 5_{MIN}, 5_{STD} and 5_{MAX} overlap one another as illustrated in FIG. 18, there is then no region to be observed in white; the color to be observed changes with observation positions (angles) when light of all the wavelengths can be observed simultaneously and a wavelength range of λ_{MIN}-λ_{STD}-λ_{MAX} is included in a visible light region.

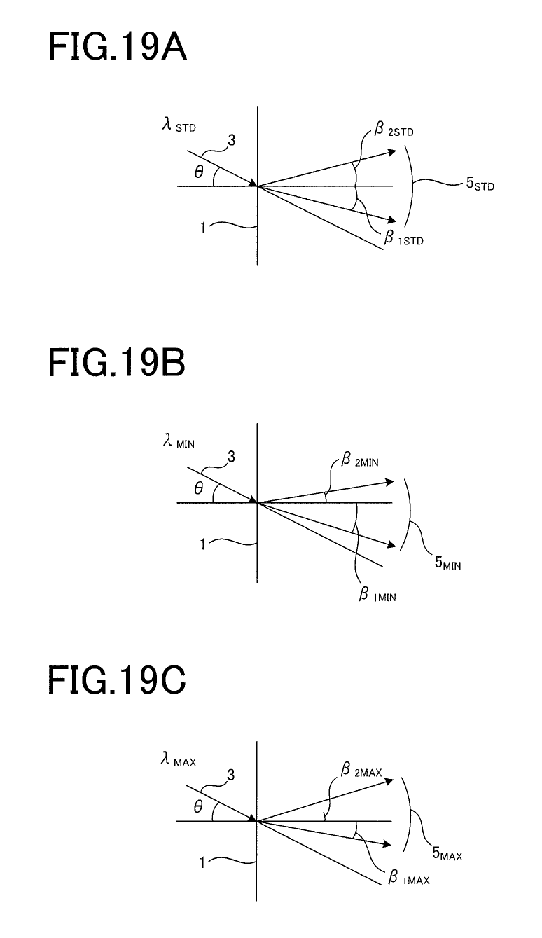

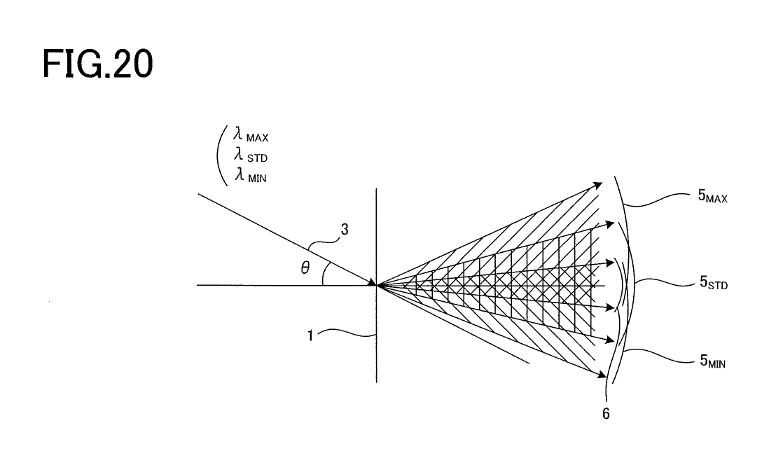

FIGS. 19A, 19B, and 19C conceptually illustrate how a wide observation region set for the computer-generated hologram 1 changes with wavelengths. FIG. 20 illustrates diffraction of each wavelength when the observation region set for the computer-generated hologram used in the projector screen of the first example according to the present embodiment is wide.

Upon the incidence of the minimum and maximum wavelengths λ_{MIN} and λ_{MAX} (FIGS. 19B and 19C), the observation regions (the angle ranges of β_{1MIN} to β_{2MIN} and β_{1MAX} to β_{2MAX}) are shifted to a lower and an upper side, respectively, as compared with the incidence of the standard wavelength λ_{STD}, as in the case of the narrow observation region of FIGS. 17A to 17C. However, the observation region is so wide that when the hologram is observed in the vicinity 6 (angle range of β_{1MAX} to β_{2MIN}) of the front where all diffraction light 5_{MIN}, 5_{STD} and 5_{MAX} overlap one another as illustrated in FIG. 20, all the wavelengths can be observed simultaneously. Accordingly, as long as the observer moves within such a region, there is no substantial change in the color to be observed.

The condition for setting the region 6 where all the assumed wavelengths can be observed is that, as can be seen from FIG. 20, the maximum diffraction angle β_{2MIN} of the minimum wavelength λ_{MIN} in the assumed wavelength range is larger than the minimum diffraction angle β_{IMP}); of the maximum wavelength λ_{MAX}. When the diffraction light 5_{MIN}, 5_{STD} and 5_{MAX} are distributed with respect to the zero-order transmission light on the opposite side to that illustrated in FIGS. 17A to 17C to FIG. 20, this relation is reversed; on the basis of the zero-order transmission light, the maximum diffraction angle β_{2MIN} of the minimum wavelength λ_{MIN} with respect to the zero-order transmission light is larger than the minimum diffraction angle β_{1MAX} of the maximum wavelength λ_{MAX}.

The sufficient condition for allowing all the wavelengths to overlap one another so that they can be observed in white is that λ_{MIN}=450 nm and λ_{MAX}=650 nm. As far as at least the computer-generated hologram 1 with the maximum diffraction angle β_{2MIN} of the minimum wavelength λ_{MIN}=450 nm being larger than the minimum diffraction angle β_{1MAX} of the maximum wavelength λ_{MAX}=650 nm is concerned, the hologram 1 can thus be observed in white with no color change in the region 6.

From the above, it is understood that for observing all the desired wavelengths in a certain observation region, what is needed is only the determination of the observation region β_{1STD} to β_{2STD} for the standard wavelength λ_{STD} according to the following steps.

At step (a), the incident angle θ of the reconstructing illumination light 3 is determined.

At step (b), the range 6 of the desired observation angle at which the hologram is seen in white is determined. That is, the minimum diffraction angle γ₁ (ββ_{1MAX}) to the maximum diffraction angle γ₂ (=β_{2MIN}) is determined.

It is here noted that the minimum diffraction angle γ₁ and the maximum diffraction angle γ₂ are defined for the zero-order transmission light. In the distribution of FIGS. 17A to 17C to FIG. 20, θ<γ₁≦γ₂, and in the distribution opposite to that of FIGS. 17A to 17C to FIG. 20, θ>γ₁≧γ₂.

At step (c), the desired observation wavelength is determined (the minimum wavelength λ_{MIN} to the maximum wavelength λ_{MAX}).

At step (d), the standard wavelength λ_{STD} is determined in the range of λ_{MIN}≦_{STD}≦λ_{MAX}.

At step (e), using the following expression (13) on the basis of the fundamental expression (12) for diffraction gratings, the minimum diffraction angle β_{1STD} at the standard wavelength λ_{STD} is calculated from the minimum diffraction angle γ₁ and the maximum wavelength λ_{MAX}.

sin θ_{d}−sin θᵢ=mλ/d (12)

where m stands for a diffraction order, d for a pitch of the diffraction grating, λ for a wavelength, θᵢ for an incident angle, and θ_{d} for a diffraction angle.

(sin γ₁−sin θ)/λ_{MAX}=(sin β_{1STD}−sin θ)/λ_{STD}

sin β_{1STD}=sin θ+(sin γ₁−sin θ)×λ_{STD}/λ_{MAX} (13)

At step (f), using the following expression (14) on the basis of the fundamental expression (12) for diffraction gratings, the maximum diffraction angle β_{2STD} at the standard wavelength λ_{STD} is likewise calculated from the maximum diffraction angle γ₂ and the minimum wavelength λ_{MIN}.

(sin γ₂−sin θ)/λ_{MIN}=(sin β_{2STD}−sin θ)/λ_{STD}

sin β_{2STD}=sin θ+(sin γ₂−sin θ)×λ_{STD}/λ_{MIN} (14)

Then, a computer-generated hologram 1 is fabricated in such a way that the minimum diffraction angle β_{1STD} and the maximum diffraction angle β_{2STD} are obtainable at the incident angle θ of illumination light and the standard wavelength λ_{STD}, thereby obtaining a diffuse hologram wherein the wavelengths λ_{MIN} to λ_{MAX} can be observed at the incident angel θ of the reconstructing light illumination 3 in the observation angle range of γ₁ to γ₂ and so the hologram 1 can be seen in white.

The above demonstrates how to calculate the diffraction angle range of β_{1STD} to β_{2STD} used for calculations when the desired incident angle θ of illumination light, the diffraction range of γ₁ to γ₂ and the wavelength range of λ_{MIN} to λ_{MAX} are provided.

On the other hand, the condition for setting a region wherein, when the minimum diffraction angle β_{1STD} and the maximum diffraction angle β_{2STD} are provided with respect to the standard wavelength λ_{STD} and the incident angle θ of illumination light, all the light of the wavelength range of λ_{MIN} to λ_{MAX} can be simultaneously observed and seen in white is given as follows, using the minimum diffraction angle β_{1MAX}=γ₁ of the maximum wavelength λ_{MAX} and the maximum diffraction angle β_{2MIN}=γ₂ of the minimum wavelength λ_{MIN}.

(1) In a case where diffraction light exists on the positive side with respect to the zero-order transmission light (FIGS. 17A to 17C to FIG. 20),

γ₂≧γ₁

sin γ₂≧sin γ₁

From expressions (13) and (14),

sin θ+(sin β_{2STD}−sin θ)×λ_{MIN}/λ_{STD}

≧sin θ+(sin β_{1STD}−sin θ)×λ_{MAX}/λ_{STD}

(sin β_{2STD}−sin θ)×λ_{MIN}≧(sin β_{1STD}−sin θ)×λ_{MAX}

### Since sin β_{2STD}> sin θ,

λ_{MIN}/λ_{MAX}≧(sin β_{1STD}−sin θ)/(sin β_{2STD}−sin θ) (15)

(2) In a case where diffraction light exists on the negative side with respect to the zero-order transmission light (opposite to the examples of FIGS. 17A to 17C to FIG. 20),

γ₂≧γ₁

sin γ₂≦sin γ₁

From expressions (13) and (14),

sin θ+(sin β_{2STD}−sin θ)×λ_{MIN}/λ_{STD}

≦sin θ+(sin β_{1STD}−sin θ)×λ_{MAX}/λ_{STD}

(sin β_{2STD}−sin θ)×λ_{MIN}≦(sin β_{1STD}−sin θ)×λ_{MAX}

### Since sin β_{2STD}> sin θ,

λ_{MIN}/λ_{MAX}≧(sin β_{1STD}−sin θ)/(sin β_{2STD}−sin θ) (15)

Thus, expression (15) is satisfied irrespective of whether the diffraction light is on the positive side or on the negative side.

This expression (15) means that if the diffraction angle range of β_{1STD} to β_{2STD} at a certain standard wavelength λ_{STD} is set in such a way as to meet expression (15) when the incident angle θ of illumination light and the desired observation wavelength range of λ_{MIN} to λ_{MAX} are provided, there is a range of γ₁ to γ₂ where all wavelengths within the desired viewing wavelength range of λ_{MIN} to λ_{MAX} can be simultaneously observed.

Transformation of expression (15) gives

sin θ≧λ_{MAX} sin β_{1STD}−λ_{MIN} sin β_{2STD})/(λ_{MAX}−λ_{MIN}) (16)

This expression (16) means that only when the incident angle θ of illumination light is set in such a way as to meet expression (16) where the desired observation wavelength range of λ_{MIN} to λ_{MAX} and the diffraction angle range of β_{1STD} to β_{2STD} at a certain standard wavelength λ_{STD} are provided, there is a range of γ₁ to γ₂ where all the wavelengths within the desired observation wavelength range of λ_{MIN} to λ_{MAX} can be simultaneously observed.

The above discussions have held true only for the plane including the normal to the elemental hologram 1 and the illumination light 3. Within a plane including the normal to the elemental hologram 1 and perpendicular to the plane, a distribution range at the minimum wavelength λ_{MIN} provides a region that can be observed in white. This is because within this plane, diffraction light is distributed on both sides of illumination light. The range of this region may be determined by the transformation of the observation region at the standard wavelength λ_{STD}, as mentioned above.

The elemental holograms 1 in the elemental hologram group 11 have the same specification. With this configuration, data amount can be reduced, and the computer-generated hologram 1 can be fabricated in a short time and at low cost.

Further, at least some elemental hologram groups 11 may be constituted of the elemental holograms 1 having the same specification. In this case, the number of elemental hologram groups 11 having the same specification is arbitrary. With this configuration, data amount can further be reduced, and the computer-generated hologram 1 can be fabricated in a shorter time and at lower cost. Further, all the elemental hologram groups may have the same specification.

Thus, according to the present embodiment, the hologram 1 has the relief part, wherein the hologram 1 reflects a given white light incident thereon at a given angle from one side, while transmits a given white light incident thereon at a given angle from the other side, and diffraction efficiency for transmitted light and diffraction efficiency for reflected light differ from each other, thereby achieving high transparency and clear and bright reflection of a projected image.

Further, in the hologram 1 according to the present embodiment, the diffraction efficiency for transmitted light is lower than the diffraction efficiency for reflected light, thereby achieving higher transparency and clear and bright reflection of a projected image.

In the hologram 1 according to the present embodiment, the ratio of the diffraction efficiency for transmitted light to the diffraction efficiency for reflected light is less than 0.2, thereby achieving higher transparency and clear and bright reflection of a projected image.

In the hologram 1 according to the present embodiment, the ratio of the diffraction efficiency for transmitted light to the diffraction efficiency for reflected light is less than 0.1, and the diffraction efficiency for reflected light is equal to or more than 60%, thereby achieving higher transparency and clear and bright reflection of a projected image.

In the hologram 1 according to the present embodiment, the depth of the relief part is set to a plurality of different values. This can increase the diffraction efficiency and allow a projected image to be brightly and clearly reflected.

The hologram 1 used in a light transmissive reflector plate 10 is the computer-generated hologram 1, thereby making the light transmissive reflector plate 10 more practical.

The light transmissive reflector plate 10 includes the hologram 1, wherein the light transmissive reflector plate 10 reflects a given white light incident thereon at a given angle from one side of the hologram 1, while transmits a given white light incident thereon from the other side thereof, and diffraction efficiency for transmitted light and diffraction efficiency for reflected light differ from each other, thereby achieving high transparency and clear and bright reflection of a projected image.

The light transmissive reflector plate 10 according to the present embodiment has the reflective layer formed in the relief part of the hologram 1, thereby allowing a projected image to be brightly and clearly reflected.

The light transmissive reflector plate 10 according to the present embodiment has the low-diffraction-efficiency layer 4 that is disposed so as to fill up the relief part of the hologram 1 and reduces the diffraction efficiency for light transmitted through the hologram, thereby achieving higher transparency.

In the light transmissive reflector plate 10 according to the present embodiment, the difference between the refractive index of the hologram 1 and the refractive index of the low-diffraction-efficiency layer 4 is set to a value equal to or less than 0.25, thereby achieving higher transparency.

The screen 10 according to the present embodiment uses the light transmissive reflector plate 10, thereby achieving higher transparency and clear and bright reflection of a projected image.

While the projector screen has been described based on the preferred embodiments, the present invention is not limited to the above embodiments, but may be variously modified.

### REFERENCE SIGNS LIST

1: Computer-generated hologram (hologram, light transmissive reflector plate)
2: Substrate (light transmissive reflector plate)
3: Reflective layer
4: Low-diffraction-efficiency layer
10: Projector screen
11: Elemental hologram group
20: Projection system
P: Projector
E: White light observation region

1. A hologram comprising a relief part, wherein
the hologram reflects a given white light incident thereon at a given angle from one side, while transmits a given white light incident thereon at a given angle from the other side, and
diffraction efficiency for transmitted light and diffraction efficiency for reflected light differ from each other.

2. The hologram according to claim 1, wherein
the diffraction efficiency for transmitted light is lower than the diffraction efficiency for reflected light.

3. The hologram according to claim 2, wherein
a ratio of the diffraction efficiency for transmitted light to the diffraction efficiency for reflected light is less than 0.2.

4. The hologram according to claim 3, wherein
the ratio of the diffraction efficiency for transmitted light to the diffraction efficiency for reflected light is less than 0.1, and
the diffraction efficiency for reflected light is equal to or more than 60%.

5. The hologram according to claim 1, wherein
the depth of the relief part is set to a plurality of different values.

6. The hologram according to claim 1, comprising a computer-generated hologram.

7. A light transmissive reflector plate comprising the hologram as claimed in claim 1, wherein
the reflector plate reflects a given white light incident thereon at a given angle from one side of the hologram, while transmits a given white light incident thereon from the other side of the hologram, and
diffraction efficiency for transmitted light and diffraction efficiency for reflected light differ from each other.

8. The light transmissive reflector plate according to claim 7, further comprising a reflective layer formed in the relief part of the hologram.

9. The light transmissive reflector plate according to claim 7, further comprising a low-diffraction-efficiency layer that is disposed so as to fill up the relief part of the hologram and reduces the diffraction efficiency for light transmitted through the hologram.

10. The light transmissive reflector plate according to claim 9, wherein
the difference between the refractive index of the hologram and the refractive index of the low-diffraction-efficiency layer is set to a value equal to or less than 0.25.

11. A screen comprising the hologram as claimed in claim 1.

12. A projection system comprising:
the screen as claimed in claim 11; and
a projector that emits a given white light toward the screen at a given angle.

13. A screen comprising the light transmissive reflector plate as claimed in claim 7.
